(19) United States
(12) Patent Application Publication
(10) Pub. No.: US 2011/0247522 A1
(43) Pub. Date: Oct. 13, 2011

(54) METHOD OF ADVANTAGEOUS MANIPULATION OF THE SOLID PIGMENT COLORS

(76) Inventors: Krzysztof NAUKA, Palo Alto, CA (US); Hou T. Ng, Palo Alto, CA (US); Eric G. Hanson, Burlingame, CA (US)

(21) Appl. No.: 12/758,575

(22) Filed: Apr. 12, 2010

(51) Int. Cl. C09C 1/00; C08L 33/20; C08L 33/02; C08L 33/06; C08L 67/00

(52) U.S. Cl. 106/400; 524/562; 524/599; 524/556; 524/565

(57) ABSTRACT

A method is provided for adjusting the color associated with a pigment particle, to achieve a desired value of the L*a*b* color space associated with such pigment particle. The method comprises the step of reducing the amount of impurities vicinal to the pigment particle in order to achieve the desired L*a*b* color coordinate, or increasing the amount of impurities vicinal to the pigment particle in order to achieve the desired L*a*b* color coordinate. A pigment particle composition comprising pigment particles and impurities with a desired value of the L*a*b* color coordinate is also provided.

### BACKGROUND OF THE INVENTION

Digital commercial printing presents an enormous business opportunity. Introduction of the new printing solutions consuming large numbers of pigmented inks and accompanied by ever present pressure on the cost of consumables must be accompanied by the corresponding ink development offering consistently high print quality at low cost. This can only be accomplished by using low cost off-the-shelf pigments with performance tailored to individual commercial printing applications. However, traditional low cost pigments may not provide a large enough color gamut. In addition, tailoring of the pigment properties (e.g., encapsulation) may cause undesirable pigment color changes further limiting its application.

Embodiments of this invention are aimed at providing cost-effective chemical methods facilitating the adjustment of low cost pigment colors to achieve desired color characteristics. Depending on the specific application, this could mean increasing the color gamut, making it similar to the gamut achievable on silver halide paper or for advanced offset printing. Furthermore, increasing saturation in certain hues is advantageous as a means to differentiate products from those of competitors. These and other advantages will be apparent from the detailed description that follows.

### BRIEF DESCRIPTION OF THE DRAWINGS

FIG. 1 is a comparison of the magnitude and effect of the color change with the overall available color gamut for two selected printing solutions shown in FIG. 1A and FIG. 1B.

### DETAILED DESCRIPTION OF THE PRESENT INVENTION

The present invention provides for a cost effective chemical approach facilitating the adjustment of the pigment color to achieve the desired color characteristic. Depending on the specific application, the pigment color can be adjusted to desired values of the L*a*b* coordinates within the CIELAB color space, thus expanding the color gamut achievable by the desired printing process. Another use for adjusted pigments is to increase saturation in certain hues to differentiate pigmented ink or ink products from alternative commercial products.

For purposes of this invention, a pigment is a solid particle of a chromophore with dimensions ranging from 10 nm to several microns. Commercial pigments are frequently formulated to contain pigment (chromophore) particles and additives acting as dispersants, anti-oxidants, and species controlling electrical charges and providing other desired rheological and thermodynamical properties of the commercial pigment. A commercial pigment may also be provided as a dispersion in a liquid solvent. For purposes of this invention, pigmented ink refers to a printing-ready mixture containing pigments and additional additives facilitating the desired printing process.

CIE L*a*b* (“CIELAB”) is the most complete color space specified by the International Commission on Illumination (Commission Internationale d'Eclairage, hence its CIE initials). It describes all the colors visible to the human eye and was created to serve as a device independent model to be used as a reference. The three coordinates of CIELAB represent the lightness of the color (L*=0 yields black and L*=100 indicates diffuse white; specular white may be higher), its position between red/magenta and green (a*, negative values indicate green while positive values indicate magenta) and its position between yellow and blue (b*, negative values indicate blue and positive values indicate yellow).

Since the L*a*b* model is a three-dimensional model, it can only be represented properly in a three-dimensional space. Two-dimensional depictions a*b* are chromaticity diagrams or sections of the color solid with a fixed lightness. The embodiments of this invention refer to color adjustments as defined by the appropriate changes of the a* and b* color coordinates.

Since all organic pigments of interest for digital printing applications exhibit very high absorption coefficients, their color appearance is determined by the electronic states within a relatively thin pigment surface region approximately defined by the inverse of the absorption coefficient. These states are, in turn, defined by the fundamental electronic nature of the chromophore molecule within the surface region and by interaction among the chromophore molecules, and by their interactions with the physicochemical vicinity surrounding the pigment particles. The fundamental electronic properties of a chromophore are invariant unless the crystalline structure of the pigment particles is changed. However, one can modify the pigment's vicinity to induce a desirable color change.

The pigment vicinity is defined as polar and non-polar impurities in the form of molecules or assemblies of molecules at the pigment particle's surface or within distance from the pigment particle's surface at which electrostatic and electro-dynamic interactions between the pigment surface molecules and impurities occur. This distance is usually less than 10 nm. Included in this distance is the medium which may optionally include a solvent in which the pigment particles and impurities reside. The modification of the pigment's vicinity can be accomplished by modifying the type, concentration and distribution of impurities on the pigment particle's surface and in the vicinity of the pigment particle's surface.

The electrostatic and electrodynamic interactions between the surface region of a pigment particle, and the impurities in its vicinity is dependent on the nature of the pigment's surface region and the surrounding polar and non-polar impurities. It is also dependent on the physicochemical properties of the medium in which the pigment particles and the surrounding impurities reside.

Impurities present in commercial pigments may be of a polar and/or non-polar nature. These impurities may be present in pigment powders as unintentional residues of the pigment fabrication. Alternatively, they may be intentionally added by the pigment vendor to adjust some of the pigment properties.

In the following detailed description, numerous specific details are set forth in order to provide a thorough understanding of the embodiments of the invention. However, it will be understood by those skilled in the art that the embodiments of the invention may be practiced without these specific details. In other instances, well-known methods, procedures, and components have not been described in detail so as not to obscure the present invention.

In one embodiment, the color change was accomplished by modifying the interactions between the pigment particles and the impurities. The interaction can be accomplished by soaking the pigment powder in a solvent causing rearrangement of the impurities in the vicinity of the pigment particles and then removing the solvent without removing the impurities. The desired color change modification is due to the changed interactions between the pigment particles and impurities. In this case, no material was extracted from the pigment powder.

In another embodiment, the color change was accomplished by removing impurities from the vicinity of the pigment particles. This can be accomplished by washing the pigment particles with aqueous or non-aqueous solvents of different polarities used singly or in combination. Such organic solvents are selected from the group consisting of ethyl acetate, acetone, acetonitrile, methanol, ethanol, dichloromethane, chloroform, carbon tetrachloride, pentane, hexane, dichloroethane and ether. Such inorganic solvents can be selected from the group consisting of water, aqueous acid solution of hydrocholoric acid, sulfuric acid, nitric acid, acetic acid, formic acid, hydrobromic acid, phosphoric acid and an aqueous base solution of sodium hydroxide, potassium hydroxide, lithium hydroxide, sodium bicarbonate, sodium carbonate and potassium carbonate.

In a specific embodiment, the washing can be accomplished by soaking the pigment powder in a solvent that weakens the attraction between the pigment particles and the impurities and then by removing the solvent used for washing along with the impurities.

In a specific embodiment, impurities are removed by organic extraction, including without limitation, Soxhlet extraction. The solvents used in the extraction of the impurities are selected to provide the desired suppression of attractive interactions between the pigments and the impurities.

The solvents used in the aforementioned extraction processes may include water and a variety of organic solvents that can be selected from the group consisting of ethyl acetate, acetone, acetonitrile, methanol, ethanol, dichloromethane, chloroform, carbon tetrachloride, pentane, hexane, dichloroethane and ether. In a specific embodiment, the organic solvent is methanol, chloroform or hexane.

In another embodiment, the method of reducing the amount of impurities in the vicinity of the pigment particles comprises the steps of suspending the pigment particles in water or in an organic solvent, and separating the pigment particles from the water phase or the organic solvent by filtration or centrifugation.

The methods of separation used in this invention are well known in the art. One example of a method of separation is filtration with filter having pores size smaller than pigment particle size (tens and/or hundreds nm). Another example of a method of separation is centrifugation taking advantage of the mass difference between the pigment particles and solvent and impurities. This method may require centrifugation speed exceeding few thousands RPM depending on the centrifuged mass.

The methods for reducing the number of impurities in the vicinity of pigment particles can be combined without limitation to achieve the desired color change. For example, one or more filtration or centrifugation steps can be used sequentially, or filtration and centrifugation steps can be used together sequentially.

In one embodiment, the desired modification of the interactions between the pigment particles and impurities is achieved by introducing additional impurities in the vicinity of the pigment particles.

By the methods of this invention, additional impurities can be placed in vicinity of the pigment particles by encapsulating the pigment particles in a polymer layer with moieties containing molecular groups providing the desired interactions with the pigment particles when placed in its vicinity. This approach offers an advantage of precise control of the amount and type of impurities present within a distance defined by the thickness of the encapsulating polymer layer on the pigment's surface.

In a specific embodiment, pigment particles may be encapsulated with polymers with backbone components or pendant groups exhibiting the desired electrical polarity. Examples of these groups may include but are not limited to alkyl, alkenyl, phenyl, benzyl, halo group, hydroxyl, carbonyl, aldehyde, carboxylate, carboxyl, ester, peroxy, amine, imine, imide, azo, cyanate, nitrite, nitrile, nitro, nitroso, phosphate, sulfonyl, sulfo, and thiocyanate. The encapsulation polymer may include styrene acrylate-based polymers, ethylene acrylate-based polymers, polyester, copolymers of ethylene and methacrylic acid, copolymers of ethylene and acrylic acid or acrylonitrile-based polymers. The resulting polymer coating may completely or only partially cover the pigment particles.

In a specific embodiment, the encapsulation may be accomplished by using any of the processes known in the art, including without limitation, dispersion polymerization, miniemulsion polymerization, microemulsion polymerization, milling, shear-induced microfluidization, phase separation and by self-assembly.

By the methods of this invention, the amount of polar impurities in the vicinity of the pigment particles can be increased by dispersing the pigment particles in a solution containing these impurities, and then removing the solvent while the impurities remain mixed with the pigment. The solvent can be removed by drying. The drying methods used in this invention are well-known in the art and include without limitation evaporation, lyophilization, convective drying, contact drying, dielectric drying, supercritical drying and natural air drying. In one embodiment, the method of drying the suspension of pigment particles is evaporation. In another embodiment, the method of drying the suspension of pigment particles is lyophilization. In yet another embodiment, the method of drying is convective drying, contact drying, dielectric drying, supercritical drying or natural air drying.

In one embodiment, the number of impurities in the vicinity of the pigment particles is increased by dispersing the pigment particles in an aqueous solution of inorganic acids or bases selected so that the inorganic ions react with the pigment particles and are retained in the mixture when the solvent is removed by drying.

By the methods of the invention, the number of impurities in the vicinity of the pigment particles can be increased by dispersing the pigment particles in an aqueous inorganic acidic solution. Dispersion can be achieved by mixing and/or by addition of dispersing surfactants.

By the methods of the invention, the number of impurities in the vicinity of the pigment particles can be increased by dispersing the pigment particles in an aqueous inorganic base solution. Dispersion is achieved by mixing and/or by addition of dispersing surfactants.

The aforementioned dispersing surfactants may include without limitation (1) anionic surfactants including a variety of sulfate, sulfonate or carboxylate anions, (2) cationic surfactants including a variety of quaternary ammonium cations, or zwitterionic components, and (3) nonionic species such as, for example, fatty acids.

Without limitation, the acid in the acidic solution is selected from the group consisting of hydrochloric acid, sulfuric acid, nitric acid, acetic acid, formic acid hydrobromic acid and phosphoric acid. In another embodiment, the acid in the acidic solution is sulfuric acid. In another embodiment, the pH of the acidic solution is from about 0-7. In another embodiment, the pH of the acidic solution is from about 1-5. In another embodiment, the pH of the acidic solution is about 3.

Without limitation, the base used in the basic solution is selected from the group consisting of sodium hydroxide, potassium hydroxide, lithium hydroxide, sodium bicarbonate, sodium carbonate and potassium carbonate. In another embodiment, the base in the basic solution is sodium hydroxide. In another embodiment, the pH of the basic solution is from about 7-14. In another embodiment, the pH of the basic solution is from about 8-12. In another embodiment, the pH of the basic solution is about 11.

This invention provides in one embodiment, a method for preparing a composition comprising pigment particles and polar impurities, wherein the vicinity of the pigment particles is modified to induce a desirable color change. In another embodiment, the invention also provides for a method for the preparation of pigmented ink compositions. The pigmented ink composition comprises pigment particles and polar impurities, wherein the vicinity of the pigment particles is modified to induce a desirable color change and by additives facilitating the printing process by selected printing technique. The same moieties may act as impurities by modifying the color and acting as additives enabling the printing.

By the methods of the invention, a composition is prepared comprising pigment particles and impurities wherein the vicinity of the pigment particles is modified to induce a desirable pigment color change achieved by increasing or decreasing the a* coordinate and/or increasing or decreasing the b* coordinate or any combination thereof in the CIE L*a*b* color space. This color modification is obtained by increasing or decreasing the number of impurities that may interact with the pigment's particle surface and are present in its vicinity.

In one embodiment of the invention, the pigment composition comprises one pigment with modified a* or b* of the L*a*b* color space or multiple pigments with modified a* or b* of the L*a*b* color space. In another embodiment, the changed a* and/or the changed b* results in increasing the spectrum of available desired color hues for existing pigment solutions.

By the methods of the invention, the pigment particles in the pigmented ink have a diameter in the range of from about 50-500 nm. However, these diameter ranges are non-limiting and can vary depending upon the specifications required for individual electronic printing application.

By the methods of the invention, several forms of the pigment particles can be used, including without limitation powders, clusters, granules, crystals, dusts and aggregates. In one embodiment, the pigment particles are in the form of a powder. In another embodiment, the pigment particles are in the form of a crystalline powder. In another embodiment, the pigment particles are in the form of a non-crystalline powder. In another embodiment, the powder is dispersible in water. In another embodiment, the powder is dispersible in polar and non-polar organic solvents.

By the methods of the invention, the pigmented ink composition having pigments with modified color coordinates can be deposited on a medium suitable for electronic printing applications. Such medium includes without limitation paper, plastic, rubber and cloth. In one embodiment, the dye composition can be deposited on a coated or non-coated medium such as paper, plastic, rubber and cloth. In one embodiment, the medium is coated. In another embodiment, the medium is non-coated. In another embodiment, the medium is paper. In another embodiment, the medium is plastic. In another embodiment, the medium is rubber. In another embodiment, the medium is cloth.

By the methods of the invention, the pigmented ink composition is suitable for various applications directed to depositing a thin colored film on a medium, including without limitation, printing and, in particular, digital printing applications.

In one embodiment, the digital printing applications utilize an electronic printing device selected from the group consisting of an inkjet printer, a bubble jet printer, a laser printer, a photocopier and a fax machine. In another embodiment, the electronic printing device delivers the pigment composition as liquid ink, or a solid toner.

By the methods of the invention, the impurities involved in pigment's color modification include without limitation byproducts of the fabrication of the pigment particles or are intentionally introduced after the fabrication of the pigment particles. In one embodiment, these impurities are byproducts of the fabrication of the pigment particles. In another embodiment, they are introduced after the fabrication of the pigment particles is completed.

In one embodiment, the amount of the color modifying impurities in the vicinity of the pigment particles is reduced or increased relative to the amount present upon receipt from the pigment vendor.

In another embodiment, the amount of the color modifying impurities in the vicinity of the pigment particles is reduced relative to the amount present upon receipt from the pigment vendor.

In another embodiment, the amount of the color modifying impurities in the vicinity of the pigment particles is increased relative to the amount present upon receipt from the pigment vendor.

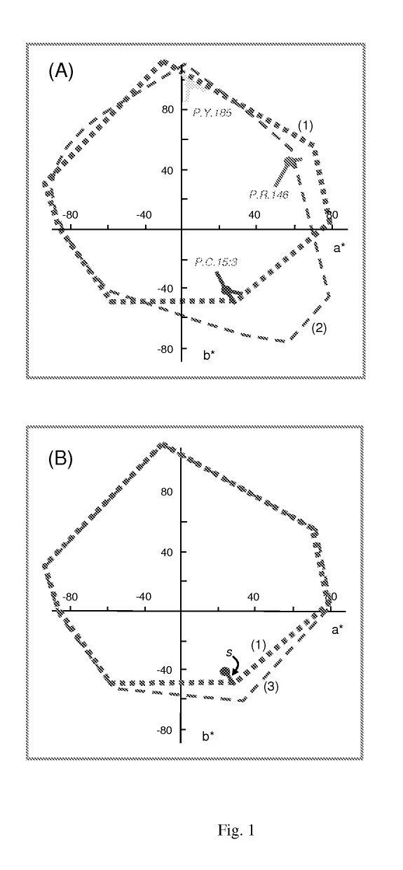

To illustrate the various embodiments of the invention, the data shown in the Tables and the Figures indicate that multiple pigment treatments, each providing a specific shift of the color coordinates, can be combined into a process to shift both color coordinates to desired values. The observed color modifications are visible. Their impact on the print performance can be demonstrated by projecting the shifts of the a* and b* on the color gamut of selected printing solutions as shown in FIG. 1A and FIG. 1B.

While the data shown in the Tables and Figures was obtained using several commercial pigments, it can be expanded to encompass a wide range of commercial pigments, including without limitation crystalline and non-crystalline pigments.

The following Examples illustrate the various embodiments of the invention.

### Example 1

This Example illustrates the color changes introduced by subsequent extractions (Soxhlet extraction) of the impurities from selected commercial pigments. The extraction employed a sequence of organic solvents with increasing polarity. The solvents used include hexane, toluene, dichloromethane (DCM) and water. This Example illustrates color modification where impurities were removed from the vicinity of the pigment. In most cases change of both a* and b* color coordinates occurs as the vicinity of the pigment particles is modified. However, in selected cases change of one of the color coordinate is several times larger than that of the other coordinate. For example, as shown in Table 1(b), in the case green pigment P.Gr.7 BASF Heliogen Green extraction of impurities with hexane reduced a* by 16% (as compared to the original value) while b* was almost unchanged. Conversely, as shown in Table 1(d), hexane extraction from BASF yellow pigment Paliotol Orange (P.Y.139) reduced b* while leaving a* mostly unchanged. The results are shown in Tables 1(a), 1(b), 1(c), 1(d), 1(e) and 1(f) for various pigments.

TABLE 1(a)
Color: Cyan, C.I. name: P.C.15:3, Vendor:
BASF, Vendor name: Heliogen Blue

| Pigment state | a* | b* |
|---|---|---|
| as-received | 25.09 | −43.48 |
| after hexane | 27.18 | −45.68 |
| after toluene | 23.76 | −40.08 |
| after DCM | 24.23 | −42.68 |
| After H₂O | 25.81 | −45.07 |

TABLE 1(b)
Color: Green, C.I. name: P.Gr.7, Vendor:
BASF, Vendor name: Heliogen Green

| Pigment state | a* | b* |
|---|---|---|
| as-received | −32.24 | −5.85 |
| after hexane | −37.40 | −5.41 |
| after toluene | −35.79 | −5.01 |
| after DCM | −37.15 | −4.85 |
| After H₂O | −32.70 | −4.91 |

TABLE 1(c)
Color: Yellow, C.I. name: P.Y.185, Vendor:
BASF, Vendor name: Paliotol Yellow

| Pigment state | a* | b* |
|---|---|---|
| as-received | 2.82 | 109.97 |
| after hexane | 2.46 | 108.55 |
| after toluene | 3.17 | 106.77 |
| after DCM | 3.62 | 106.69 |
| After H₂O | 3.03 | 108.14 |

TABLE 1(d)
Color: Orange, C.I. name: P.Y.139, Vendor:
BASF, Vendor name: Paliotol Yellow

| Pigment state | a* | b* |
|---|---|---|
| as-received | 27.80 | 102.02 |
| After hexane | 27.92 | 100.97 |
| After toluene | 28.35 | 96.27 |
| after DCM | 26.69 | 102.66 |
| After H₂O | 28.92 | 99.67 |

TABLE 1(e)
Color: Magenta, C.I. name: P.R.146, Vendor:
BASF, Vendor name: Paliogen Red

| Pigment state | a* | b* |
|---|---|---|
| as-received | 58.04 | 34.63 |
| After hexane | 58.96 | 35.65 |
| After toluene | 54.36 | 33.74 |
| after DCM | 48.80 | 30.69 |
| After H₂O | 49.53 | 31.84 |

TABLE 1(f)
Color: Red, C.I. name: P.R.122, Vendor:
BASF, Vendor name: Paliogen Red

| Pigment state | a* | b* |
|---|---|---|
| as-received | 46.81 | 4.71 |
| after hexane | 45.49 | 4.67 |
| after toluene | 46.93 | 4.93 |
| after DCM | 46.80 | 4.90 |
| After H₂O | 46.11 | 4.28 |

### Example 2

This Example illustrates color changes introduced in a selected commercial pigment by washing with water. Washing was accomplished by repetitive centrifuging (10 min/30,000 rpm with water solvent discarded after each centrifugation step). This Example illustrates color modification where impurities were removed from the vicinity of the pigment. In most cases change of both a* and b* color coordinates occurs as the vicinity of the pigment particles is modified. However, in selected cases change of one of the color coordinate is several times larger than that of the other coordinate. In the example shown in Table 2, color coordinate b* was changed by approximately 15% while a* coordinate remained unchanged. The results are shown in Table 2.

TABLE 2
Color: Cyan, C.I. name: P.C.15:3, Vendor:
Clariant, Vendor name: Hostaperm Blue

| Pigment state | a* | b* |
|---|---|---|
| as-received | 25.71 | −41.00 |
| After centrifuging ten times | 25.31 | −35.57 |

### Example 3

This Example illustrates the color changes introduced in a selected commercial pigment encapsulating pigment particles with a thin layer of polymer comprising carbonyl moieties in the vicinity of the pigment surface. This illustrates color modification where species (in this case selected moieties comprising the polymer macromolecules) interacting with the pigment's surface molecules impurities were placed in the vicinity of the pigment particles. The results are shown in Table 3.

TABLE 3
Color: Cyan, C.I. name: P.C.15:3, Vendor:
Clariant, Vendor name: Hostaperm Blue

| Pigment state | a* | B* |
|---|---|---|
| as-received | 25.71 | −41.00 |
| after encapsulation | 22.09 | −39.21 |

### Example 4

This Example illustrates the color change introduced in a selected commercial pigment by soaking pigment particles in an aqueous acid or base solution for 6 hours and then removing aqueous solvent by drying. This illustrates color modification where impurities were additional polar moieties introduced in the vicinity of the pigment particles. In most cases change of both a* and b* color coordinates occurs as the vicinity of the pigment particles is modified. However, in selected cases change of one of the color coordinate is significantly larger that of the other coordinate. The results are shown in Table 4.

TABLE 4
Color: Yellow, C.I. name: P.Y.74, Vendor:
Heubach, Vendor name: Heuco Yellow

| Pigment state | a* | B* |
|---|---|---|
| as-received | 9.01 | 112.01 |
| Acid solution (aqueous/H2SO4, pH = 3) | 8.31 | 104.06 |
| Base solution (aqueous/NaOH, pH = 11) | 10.23 | 105.69 |

### Example 5

Multiple pigment treatments, each providing specific shift of the color coordinates, as in the Examples above, can be combined into a process shifting both color coordinates to desired values.

The observed color modifications are clearly visible. Their impact on the print performance can be demonstrated by projecting the shifts of the a* and b* on the color gamut of selected printing solutions like the HP Indigo 5000 digital press using Indigo paper and the HP Z3100 large format printer using pigmented inks and photo glossy paper (FIG. 1). Color gamut contour describes color space achievable by the standard set of pigments. Shift of the pigment color coordinates translates into change of the color gamut contour. The maximum distance (DE) from the gamut boundary to a point on the gray axis with the same lightness is about 100 in the case of the Indigo and about 120 in the case of Z3100. Some of the demonstrated color coordinate shifts can reach almost 5% to 10% of these values and would constitute an unacceptable color difference for color critical applications like proofing (assuming “common sense” rule that a DE difference of 1 is visible). Conversely, intentionally engineered pigment color shifts may provide an opportunity for expanding the available color gamut, particularly for further extension of the HP Indigo 5000 digital press performance in the “blue” region.

FIG. 1 shows selected pigment color modifications projected onto two exemplary color gamut of the HP indigo 5000 digital press.

FIG. 1A shows the color gamut of the HP indigo 5000 digital press and HP Z3100 large format printer using pigmented inks and photo glossy paper. Several exemplary color shifts for three selected pigments (P.Y. 185, P.R. 146 and P.C. 153) are shown and they are anchored at dots representing the original pigment color coordinates.

FIG. 1B shows the color gamut of the HP indigo 5000 digital press and estimated modification of this gamut is obtained by shifting Cyan pigment (P.C. 153) coordinates as shown in the shifted pigment by “s.”

It is to be noted that while this Example is limited to several commercial pigments, the techniques used herein are generic enough to be applicable to other commercial pigments, crystalline and non-crystalline.

While certain features of the invention have been illustrated and described herein, many modifications, substitution, changes, and equivalents will now occur to those of ordinary skill in the art. It is, therefore, to be understood that the appended claims are intended to cover all such modifications and changes as fall within the true spirit of the invention.

What is claimed is:

1. A method of adjusting the color associated with a pigment particle to achieve a desired value of L*a*b* color space associated with such pigment particles, the method comprising the step of either reducing the amount of impurities vicinal to the pigment particle in order to achieve the desired L*a*b* color coordinate, or increasing the amount of impurities vicinal to the pigment particle in order to achieve the desired L*a*b* coordinates.

2. The method of claim 1, wherein the step of reducing the number of impurities vicinal to the pigment particle comprises washing the pigment particles with one or more inorganic or organic solvents to weaken the attraction between the pigment particles and the impurities and then by removing the solvent used for washing along with the impurities, wherein the organic solvent is selected from the group consisting of ethyl acetate, acetone, acetonitrile, methanol, ethanol, dichloromethane, chloroform, carbon tetrachloride, pentane, hexane, dichloroethane and ether, and wherein the inorganic solvent is selected from the group consisting of water, aqueous acid solution of hydrocholoric acid, sulfuric acid, nitric acid, acetic acid, formic acid, hydrobromic acid, phosphoric acid and an aqueous base solution of sodium hydroxide, potassium hydroxide, lithium hydroxide, sodium bicarbonate, sodium carbonate and potassium carbonate.

3. The method of claim 1, wherein the pigment color is adjusted by modifying the interactions between the pigment particle and the vicinal impurities by soaking the pigment particles in a solvent causing rearrangement of the impurities vicinal to the pigment particle and the removing the solvent without removing the impurities, wherein the organic solvent is selected from the group consisting of ethyl acetate, acetone, acetonitrile, methanol, ethanol, dichloromethane, chloroform, carbon tetrachloride, pentane, hexane, dichloroethane and ether, and wherein the inorganic solvent is selected from the group consisting of water, aqueous acid solution of hydrocholoric acid, sulfuric acid, nitric acid, acetic acid, formic acid, hydrobromic acid, phosphoric acid and an aqueous base solution of sodium hydroxide, potassium hydroxide, lithium hydroxide, sodium bicarbonate, sodium carbonate and potassium carbonate.

4. The method of claim 1, wherein the method of reducing the amount of impurities vicinal to the pigment particle comprises the step of suspending the pigment particles in an inorganic or organic solvent, and separating the pigment particles from the solvent by one or more filtration steps or one or more centrifugation steps, wherein the organic solvent is selected from the group consisting of ethyl acetate, acetone, acetonitrile, methanol, ethanol, dichloromethane, chloroform, carbon tetrachloride, pentane, hexane, dichloroethane and ether, and wherein the inorganic solvent is selected from the group consisting of water, aqueous acid solution of hydrocholoric acid, sulfuric acid, nitric acid, acetic acid, formic acid, hydrobromic acid, phosphoric acid and an aqueous base solution of sodium hydroxide, potassium hydroxide, lithium hydroxide, sodium bicarbonate, sodium carbonate and potassium carbonate.

5. The method of claim 1, wherein the pigment particles are dispersed in an inorganic or organic solvent using dispersing surfactants, such pigment particles also providing an interaction, thus adjusting the pigment color.

6. The method of claim 1, wherein the step of modifying the interactions between the pigment particle and the vicinal impurities comprises introducing these impurities within a thin polymer encapsulating the pigment particles.

7. The method of claim 6, wherein the polymer is selected from the group consisting of styrene acrylate-based polymers, ethylene acrylate-based polymers, polyester, copolymers of ethylene and methacrylic acid, copolymers of ethylene and acrylic acid, and acrylonitrile-based polymers.

8. The method of claim 6, wherein the step of encapsulation is selected from the group consisting of dispersion polymerization, mini-emulsion polymerization, micro-emulsion polymerization, milling, shear-induced micro-fluidization, phase separation, and self-assembly.

9. The method of claim 6, wherein the step of encapsulation comprises encapsulating the pigment particles with polymer macromolecules containing molecular groups interacting with the encapsulated pigment particles and thus providing the desired color adjustment.

10. The method of claim 9, wherein the molecular groups are selected from the group consisting of: alkyl, alkenyl, phenyl, benzyl, halo, hydrozyl, carbonyl, aldehyde, carboxylate, carboxyl, ester, peroxy, amine, imine, imide, cyanate, nitrite, nitrile, nitro, nitroso, phosphate, sulfonyl, sulfo, and thiocyanate.

11. The method of claim 6, wherein the thickness of the polymer encapsulant is less than 10 nm.

12. The method of claim 6, wherein the impurities are separate moieties entangled within the encapsulating polymer and are placed in the vicinity of the pigment particles.

13. The method of claim 1, wherein the method of increasing the number of polar impurities vicinal to the pigment particle comprises dispersing the pigment particles in an acid solution or a basic solution, and drying the dispersion of pigment particles by evaporation or lyophilization.

14. The method of claim 13, wherein the acidic ion from the acidic solution or the basic ion from the basic solution interact with the pigments particles and remain within the mixture following removal of the aqueous solvent.

15. The method of claim 13, wherein the acid in the acidic solution is selected from the group consisting of hydrochloric acid, sulfuric acid, nitric acid, acetic acid, formic acid, hydrobromic acid and phosphoric acid and wherein the pH of the acidic solution is from about 1 to 5, and wherein the base in the base solution is selected from the group consisting of sodium hydroxide, potassium hydroxide, lithium hydroxide, calcium hydroxide and magnesium hydroxide and wherein the pH of the base solution is from about 8 to 13.

16. A pigment particle composition comprising pigment particles and impurities, wherein the pigment particles have an increased spectrum of the available color hues for existing pigment solutions and a desired value of the L*a*b* color space, either with changed a* or changed b* or changed both a* and b* by either increased or decreased amount of impurities in the vicinity or on the surface of the pigment particles compared to as-received pigments.

17. The pigment particle composition of claim 16, wherein the desired value of the L*a*b* color coordinates is achieved by reducing the number of impurities vicinal to the pigment particles or by increasing the number of impurities vicinal to the pigment particles.

18. The pigment particle composition of claim 16, wherein the composition comprises one pigment with modified a* and b* of the L*a*b* color coordinates or multiple pigments with at least one of them having modified a* and b* of the L*a*b* color coordinates.

19. The pigment particle composition of claim 16, wherein the pigment particles are absorbed within or to a coated or uncoated medium selected from the group consisting of paper, plastic, rubber, cloth.

20. A pigment particle composition prepared by the method of claim 1.
